(19) United States
(12) Patent Application Publication
(10) Pub. No.: US 2004/0045128 A1
(43) Pub. Date: Mar. 11, 2004

(54) Magnetic door holder door stop

(76) Inventor: Matthew Frushour, Owensboro, KY (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/660,088

(22) Filed: Sep. 9, 2003

Related U.S. Application Data
(60) Provisional application No. 60/408,980, filed on Sep. 9, 2002.

(51) Int. Cl. E05F 5/02

(52) U.S. Cl. 16/82

(57) ABSTRACT

A door holder door stop that uses magnetic force to hold a door in an open position adjacent an interior wall. The door holder door stop includes an elongated arm having a first end and a second end, a screw disposed at the second end, the screw to fixedly secure the arm to the wall. A magnetic surface is disposed on a magnetic head, the magnetic head attached at the first end of the arm. The door holder door stop further includes a metal plate having a first side and a second side. The second side having an adhesive surface to fixedly secure the plate to the door. When the door is opened and moved to towards the wall, the first side of the metal plate is attracted to the metal surface of the arm, and therefore the door is retained in the open position.

### CROSS REFERENCES TO RELATED APPLICATIONS: None.

Statement as to rights to inventions made under Federally sponsored research and development: U.S. Provisional Application for Patent 60/408,980, filed Sep. 9, 2002, with title, “Magnetic Door Holder Door Stop” which is hereby incorporated by reference. Applicant claims priority pursuant to 35 U.S.C. Par. 119(e)(i).

### BACKGROUND OF THE INVENTION

1. Field of the Invention

The present invention relates generally to door holder door stop which provides a retaining means to stop the door in an open position when the door is opened. More specifically, the invention concerns a door holder and stop that uses magnetic force to hold the door in an open position.

2. Brief Description of Prior Art

The present invention relates to an apparatus primarily associated with the interior door of a dwelling. When an interior door is placed in the open position, the door may not remain open as desired, and swing partially or completely closed. This problem may be attributed for example, to door alignment, dwelling settlement, or a wind force passing through the dwelling.

Previously, a door was held in an open position by a wedge forced between the bottom of the door and the floor. Another prior art solution to the problem was a hook-and-eye hardware apparatus. Prior art door holders and door stops further disclose both floor and wall mounted door stopping and retaining devices that require various attachments that are recessed into, or project substantially from a door, that are complicated to both install and align in order to function properly. In addition, these devices are expensive to manufacture.

Such prior art devices have a plurality of moving parts which can eventually wear and hinder proper operation, require periodic maintenance, and additional expense of replacement. These prior art devices being too expensive for the intended purpose of simply holding the door in an open position.

There are likewise prior art devices that incorporate magnetic force, as does the present invention. These devices disclose both floor and wall mounted door stops and holders. Again, these devices include numerous and intricate fitting pads, which require specialized machinery to produce and assemble. These devices being overly complex and therefore, expensive to manufacture.

U.S. Pat. No. 2,496,691 to Berry, U.S. Pat. No. 2,815,236 to Lowinski, U.S. Pat. No. 3,100,664 to Duval, U.S. Pat. No. 3,163,453 to Stephens, U.S. Pat. No. 3,244,443 to Rogers, U.S. Pat. No. 3,578,370 to Greytok, and U.S. Pat. No. 3,701,557 to Centofante includes moving pads that have wearing and loosening characteristics which require periodic maintenance and replacement. Further, these devices are relatively difficult and expensive to manufacture because of their complex shapes and plurality of parts.

As will be seen from the subsequent description, the preferred embodiments of the present invention overcome shortcomings of the prior art.

### SUMMARY OF THE INVENTION

The present invention relates generally to a door holder door stop which provides a retaining means to stop the door in an open position when the door is opened, and more particularly, a door holder and stop that uses magnetic force to hold the door in an open position adjacent an interior wall. The door holder door stop of the present invention includes an elongated arm having a first end and a second end. A screw is disposed at the second end, the screw to fixedly secure the arm to the wall. A magnetic surface is disposed on a magnetic head, the magnetic head attached at the first end of the arm. The door holder door stop further includes a metal plate having a first side and a second side. The second side having an adhesive surface to fixedly secure the plate to the door. When the door is opened and moved to towards the wall, the first side of the metal plate is attracted to the metal surface of the arm, and therefore the door is retained in the open position.

### BRIEF DESCRIPTION OF THE DRAWINGS

FIG. 1 is a perspective view of the door holder door stop of the present invention.

FIG. 2 is a side view of the door holder door stop of FIG. 1 installed in a door and a wall.

### DESCRIPTION OF THE PREFERRED EMBODIMENT

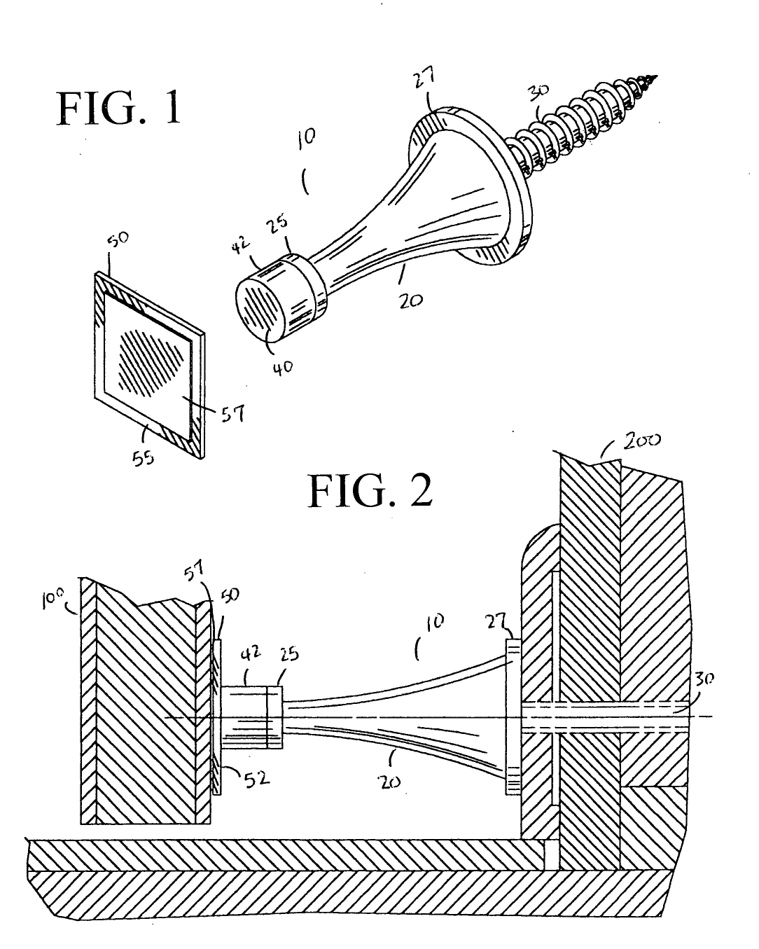

FIGS. 1-2 illustrate a preferred embodiment of a door holder door stop 10 made in accordance with the present invention. The door holder door stop 10 used to secure an interior door 100 in an open position adjacent an interior wall 200. Referring to FIG. 1, the door holder door stop 10 includes an elongated arm 20, the arm 20 generally sized and shaped to door stop arms known in the art. The elongated arm 20 has a first end 25 and a second end 27. A screw 30 is disposed at the second end 27 of the elongated arm 20, the screw 30 is an elongated adjustment member to fixedly secure the arm 20 to the wall 200 ( see FIG. 2). A magnetic surface 40 is disposed on a magnetic head 42, the magnetic head 42 attached at the first end 25 of the arm 20. In the preferred embodiment, the magnetic surface 40 and magnetic head 42 each having a cylindrical shape and each having a circumference in alignment with the circumference of the first end 25 of the arm.

The door holder door stop further includes a metal plate 50 having a first side 52 and a second side 55. The second side 55 having an adhesive surface 57 to fixedly secure the plate 50 to the door 100 ( see FIG. 2). In the preferred embodiment, the adhesive surface 57 is a two-sided tape known in the art. Further, it is preferred that the metal plate 50 have a rectangular configuration.

Referring to FIG. 2, the metal plate 50 is attached to the door 100 as described above, and the elongated arm 20 is attached to the wall 200 as described above with the magnetic head 42 longitudinally extending from the surface of the wall 200. When the door 100 is opened and moved towards the wall 200, the first side 52 of the metal plate 50 is attracted to the magnetic surface 40 of the arm 20. The magnetic head 42 having the magnetic surface 40 magnetizes the metal plate 50 so that the plate has a magnetic force. In the preferred embodiment, the magnetic surface 40 and the metal plate 50 have a flat surface, so that the magnetic force acts on the surface evenly, providing a better hold.

When the magnetic surface 40 is brought into contact with the first side 52 of the metal plate 50, the magnetic force pulls the metal plate 50 to the magnetic surface 40 of the arm 20 and effectively retains the plate 50 to the magnetic surface 40. This magnetic attraction holds the plate 50 to the magnetic surface 40, and therefore retaining the door 100 in the open position.

The magnetic hold is broken by a pull of the door 100 thereby effectively separating the metal plate 50 from the arm 20, allowing the door 100 to be closed.

The embodiment depicted in the drawing is intended to be merely exemplary, and is not intended to depict all possible shapes for a door holder door stop of the present invention. Rather, the magnetic head 42 having the magnetic surface 40 thereon, and the metal plate 50 can be of any shape having mating components as described herein.

Although the description above contains many specificities, these should not be construed as limiting the scope of the invention but as merely providing illustrations of some of the presently preferred embodiments of this invention.

Thus the scope of the invention should be determined by the appended claims in the formal application and their legal equivalents, rather than by the examples given.

I claim:

1. A door holder door stop to secure a door in an open position adjacent a wall, said door holder door stop comprising:
an elongated arm having a first end and a second end, first attaching means for securing the second end of the elongated arm to the wall,
a magnetic head attached at the second end of the elongated arm, said magnetic head having a magnetic surface, wherein the magnetic head longitudinally extends from the surface of the wall,
a metal plate having a first side and a second side,
second attaching means for attaching said second side of the plate to the door,
wherein the magnetic head is secured to the first side of the plate by a magnetic force of attraction to hold the door in an open position when the door is opened,
wherein the magnetic head and the magnetic surface each having a circumference in alignment with the circumference of the first end of the arm.

2. The door holder door stop as recited in claim 1, wherein the magnetic surface has a flat surface.

3. The door holder door stop as recited in claim 1, wherein the first side and the second side of the plate each having a flat surface.

4. The door holder door stop as recited in claim 1, wherein the second side of the plate having an adhesive surface to fixedly secure the metal plate to the door.

5. The door holder door stop as recited in claim 1, wherein the first attaching means comprising a screw disposed at the second end of the elongated arm.

6. The door holder door stop as recited in claim 1, wherein the magnetic force is broken by pulling the door such that the plate and the arm are separated.

7. The door holder door stop as recited in claim 1, wherein the plate having a rectangular configuration.

8. The door holder door stop as recited in claim 5, wherein the screw has a threaded outside wall.

9. A door holder door stop to secure a door in an open position adjacent a wall, said door holder door stop comprising:
an elongated arm having a first end and a second end, first attaching means for securing the second end of the elongated arm to the wall,
a magnetic head attached at the second end of the elongated arm, said magnetic head having a magnetic surface,
a plate having a first side and a second side,
second attaching means for attaching said second side of the plate to the door.

10. The door holder door stop as recited in claim 9, wherein the magnetic surface has a flat surface.

11. The door holder door stop as recited in claim 9, wherein the first side and the second side of the plate each having a flat surface.

12. The door holder door stop as recited in claim 9, wherein the second side of the plate having an adhesive surface to fixedly secure the metal plate to the door.

13. The door holder door stop as recited in claim 9, wherein the first attaching means comprising a screw disposed at the second end of the elongated arm.

14. The door holder door stop as recited in claim 9, wherein the first side of the plate is constructed of metal.

15. The door holder door stop as recited in claim 14, wherein the magnetic head is secured to the first side of the plate by a magnetic force of attraction to hold the door in an open position when the door is opened.

16. The door holder door stop as recited in claim 15, wherein the magnetic force is broken by pulling the door such that the plate and the arm are separated.

17. The door holder door stop as recited in claim 9, wherein the magnetic surface having a circumference in alignment with the circumference of the first end of the arm.

18. The door holder door stop as recited in claim 17, wherein the magnetic surface having a circumference in alignment with the circumference of the magnetic head.

19. The door holder door stop as recited in claim 9, wherein the plate having a rectangular configuration.

20. The door holder door stop as recited in claim 9, wherein the magnetic head longitudinally extends from the surface of the wall.

21. The door holder door stop as recited in claim 13, wherein the screw has a threaded outside wall.
